(19) United States
(12) Patent Application Publication
(10) Pub. No.: US 2025/0108744 A1
(43) Pub. Date: Apr. 3, 2025

(54) Headrest Sleeve

(71) Applicant: Illinois Tool Works Inc., Glenview, IL (US)

(72) Inventor: Marc COBOS VIDAL, Sentmenat (BCN) (ES)

(21) Appl. No.: 18/899,871

(22) Filed: Sep. 27, 2024

(30) Foreign Application Priority Data
Oct. 2, 2023 (EP) 23 201 208.8

(51) Int. Cl. B60N 2/897

(52) U.S. Cl. CPC B60N 2/897

(57) ABSTRACT

The disclosure relates to a headrest sleeve (1) having a sleeve body (2) that can be inserted into at least one opening of a frame of a vehicle seat. The headrest sleeve (1) includes a continuous axial channel (3) for receiving a headrest rod (8) and a head portion (4). When the headrest sleeve (1) is used as intended, the sleeve body (2) is inserted in the opening of the frame of the vehicle seat in such a way that the head portion (4) of the sleeve body (2) is positioned outside or on an outer surface of the frame of the vehicle seat. According to the disclosure, the head portion (4) of the sleeve body (2) includes at least one reinforcement element (5) for reinforcing and/or stiffening the head portion (4).

### RELATED APPLICATIONS

The present application claims the benefit of European Patent Application No. EP 23 201 208.8, filed Oct. 2, 2023, titled “Headrest Sleeve,” the contents of which are hereby incorporated by reference.

### BACKGROUND

The present disclosure relates generally to a headrest sleeve for receiving a headrest rod. Furthermore, the disclosure relates to a vehicle seat for a motor vehicle having a backrest as well as having a headrest.

A headrest sleeve which is used to attach a headrest to the backrest of a vehicle seat is known from commonly owned U.S. Pat. No. 7,429,086. The headrest sleeve is recessed into an opening in the backrest of a vehicle seat and serves to receive a headrest rod. To adjust the height of the headrest, the rod can be moved in the headrest sleeve and, if necessary, locked in a specified detent position. Such headrest sleeves have certainly proven themselves in individual cases. However, it has been found to be disadvantageous that the headrest rod can also move slightly in the locked position in relation to the headrest sleeve. Thus, vibrations of the vehicle or vehicle seat can cause undesirable rattling noises. To reduce rattling noise, two elastic regions are provided in the headrest sleeve, which are subjected to a spring force from the outside by a wire-shaped spring element. Further headrest sleeves having a sleeve body are known from DE19608851C2, DE29707562U1, and DE 179 17 942 A1. The sleeve bodies of the headrest sleeve known from this prior art each comprise two diametrically opposed elastic regions. The elastic regions are each subjected to a spring force by a spring element.

Although measures are already known from the prior art with which a vibration and a noise development of the headrest can be at least reduced in normal operation of the vehicle, the headrests and headrest sleeves known from the prior art demonstrate weaknesses in the event of a crash of the vehicle. In particular, in the case of a rear impact of the vehicle, the headrests are of particular importance.

In a rear impact, the chassis of the vehicle is suddenly accelerated from standstill or from a low speed to a relatively high speed. The seats of the vehicle, which are typically fixedly connected to the chassis, experience correspondingly high acceleration. This acceleration acts on the portions of the occupant that come into contact with the vehicle seat, i.e., the buttocks and lower portion of the torso. The head of the occupant remains in its initial position and at its initial speed. Because the torso of the occupant, which is connected to the seat in particular via a seatbelt, experiences considerable acceleration, the torso moves forward in relation to the head. The neck of the occupant is thereby pulled out of its normal state and deformed into an “S” configuration.

Finally, the head is accelerated forwards by the force that the neck exerts on it, wherein it simultaneously rotates about a horizontal axis. This places a great deal of stress on the neck and causes cervical spondylosis, also known as whiplash. Not only is cervical spondylosis painful and associated with a lengthy recovery period, but it also causes high economic costs. According to estimates, up to €10 billion per year is incurred in Europe for medical treatments of traffic accident-related cervical spondylosis, and in Germany far more than €600 million in costs.

### SUMMARY

The present disclosure relates generally to a headrest sleeve, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematically and in a side view, an exemplary embodiment of a headrest sleeve according to the present disclosure, namely in a front view onto the sleeve body of the headrest sleeve.

FIG. 2 illustrates schematically and in an isometric view, the head portion of the sleeve body of the headrest sleeve according to FIG. 1.

FIG. 3 illustrates schematically, a cross-section through the head portion of the sleeve body of the headrest sleeve according to FIG. 2.

FIG. 4 illustrates schematically and in a side view, a second exemplary embodiment of a headrest sleeve according to the present disclosure.

FIG. 5 illustrates schematically and in a partially cut view, the headrest sleeve according to FIG. 4.

FIG. 6 illustrates schematically, a cross-section along line A-A in FIG. 5.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” “upper,” “lower,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Active headrests can significantly minimize the risk of injury in a rear-end vehicle accident. During an impact, passengers' vehicles and bodies are accelerated forward, while their heads experience rearward acceleration. A whiplash movement occurs that can result in injury to the cervical spine and subsequent whiplash. In such a case, the headrest provides the best protection when it abuts tightly against the back of the vehicle occupant's head upon impact. However, for reasons of comfort, or sometimes out of negligence, many drivers adjust the headrest with a distance of a few cm from the back of the head. Active headrests help to quickly support the head by moving forward in the event of a rear crash.

However, the effort involved in implementing an active headrest is relatively high. Thus, there is a need to optimize a conventional headrest sleeve to effectively minimize the risk of cervical spondylosis in the event of a rear impact to the vehicle.

The problem addressed by the disclosure is solved in particular by the subject-matter of independent claim 1, which relates to a headrest sleeve which is configured to optimize a corresponding headrest assembly with regard to so-called whiplash tests. Advantageous further developments of the headrest sleeve according to the disclosure are specified in the dependent claims.

Accordingly, the disclosure relates in particular to a headrest sleeve having a sleeve body that can be inserted into at least one opening of a frame of a vehicle seat and comprises a continuous axial channel for receiving a headrest rod and a head portion. When the headrest sleeve is used as intended, the sleeve body is inserted in the opening of the frame of the vehicle seat in such a way that the head portion of the sleeve body is positioned outside or on an outer surface of the frame of the vehicle seat.

To improve the performance of the headrest sleeve, in particular during whiplash tests in which the behavior of the headrest assembly in the case of a rear impact is investigated, it is provided according to the disclosure that the head portion of the sleeve body comprises at least one reinforcement element for reinforcing, and in particular stiffening, the head portion of the headrest sleeve.

The advantages achievable with the solution according to the disclosure are obvious:

By providing the at least one reinforcement element, the region of the headrest sleeve which is not accommodated in the vehicle seat frame when the headrest sleeve is used as intended, is reinforced, and in particular stiffened. This region is particularly vulnerable in the case of a rear impact to the vehicle. By stiffening the head portion of the sleeve body accordingly, a failure of the headrest sleeve can be prevented in an easily realized yet effective manner, even in the case of a rear impact to the vehicle.

On the other hand, the at least one reinforcement element can be implemented in or on the head portion of the sleeve body without the need for a complete re-design of the headrest sleeve.

According to implementations of the headrest sleeve, it is provided that the at least one reinforcement element extends in the longitudinal direction of extension of the head portion of the sleeve body.

In particular, in embodiments of the headrest sleeve according to the disclosure, it is provided that the sleeve body has a radially outward-facing flange region in an upper region of the sleeve body, which is preferably molded onto the sleeve body and is in particular monolithically formed with the sleeve body. When the headrest sleeve is used as intended, the flange region abuts against an outer surface of the vehicle seat frame.

In other words, the flange region defines how far the headrest sleeve, or the sleeve body of the headrest sleeve can be received in the opening of the vehicle seat frame. The region of the sleeve body which is not accommodated by the vehicle seat frame when the headrest sleeve is used as intended forms the aforementioned head portion of the sleeve body.

Because the head portion is not held or supported by the chassis, this head portion is subjected to special mechanical loads, in particular in the event of a rear impact to the vehicle. To still be able to ensure the structural integrity of the headrest sleeve, it is provided according to the disclosure that the at least one reinforcement element is provided above the flange region and connected there to the head section.

In particular, the at least one reinforcement element is provided exclusively above the flange region.

According to preferred implementations of the headrest sleeve according to the disclosure, the at least one reinforcement element is molded onto the head portion of the sleeve body and preferably monolithically formed with the head portion. In this context, it is particularly suitable to design the entire sleeve body as a plastic, injection-molded part, namely together with the head portion of the sleeve body and the at least one reinforcement element.

The at least one reinforcement element can in particular be formed from the same material as the sleeve body or at least as the head portion of the sleeve body. In particular, the material of the at least one reinforcement element should have a strength/stiffness that corresponds to at least the strength/stiffness of the head portion of the sleeve body.

The at least one reinforcement element is configured to increase the bending stiffness of the sleeve body, in particular in the region of the head portion. Alternatively or additionally, the at least one reinforcement element is further configured to increase a torsion stiffness of the sleeve body, in particular in the region of the head portion.

According to embodiments of the headrest sleeve according to the disclosure, the sleeve body comprises a front side, which, when the headrest sleeve is used as intended, points in the direction of travel of the vehicle. In particular, it is provided that the at least one reinforcement element is provided on the front side of the sleeve body.

Alternatively, or additionally, however, it is also conceivable that the at least one reinforcement element is provided on a rear side of the sleeve body lying opposite the front side.

It is preferably provided that the at least one reinforcement element is provided exclusively on the front side of the sleeve body and/or on the rear side of the sleeve body.

According to a preferred implementation of the headrest sleeve according to the disclosure, the at least one reinforcement element is provided exclusively on the front side of the sleeve body, while a window region is formed in the rear side of the sleeve body.

For the at least one reinforcement element, various embodiments are possible. A reinforcement rib has proven to be particularly efficient as a reinforcement element.

The reinforcement rib has in particular a substantially L-shaped, T-shaped, or double-T-shaped cross-section.

In particular, with this embodiment of the at least one reinforcement element, the bending stiffness of the head portion of the headrest sleeve can be increased in an easily realized yet effective manner.

At the same time, a lower region of the reinforcement rib can also be connected to the flange region of the sleeve body to also increase a torsion stiffness of the head portion.

The disclosure is described in further detail below with reference to the accompanying drawings.

As explained above, there is a need for a headrest sleeve for a vehicle seat that can be easily manufactured and that improves the performance of a headrest during the whiplash test. According to the present disclosure, a headrest sleeve is proposed for this purpose, which comprises at least one reinforcement element for reinforcing a head portion of the headrest sleeve and a sleeve body of the headrest sleeve, respectively.

The embodiments shown in the drawings relate to corresponding headrest sleeves 1 for a headrest.

Although the headrest sleeves 1 described herein are generally intended for use in a headrest of a motor vehicle, the headrest sleeve 1 can be used with any suitable headrest, such as those used in aircraft, trains, ships, or the like.

The headrest sleeves 1 shown in the drawings comprise a sleeve body 2 having a proximal end (upper end) and a distal end (lower end). The sleeve body 2 comprises a tubular wall, wherein a head portion 4 of the sleeve body 2 is arranged at the proximal end, i.e., at the upper end of the sleeve body 2.

The headrest sleeve 1, and in particular the sleeve body 2, has a substantially elongated design.

The sleeve body 2 of the headrest sleeve 1 is preferably formed in one piece and extends along a longitudinal axis (longitudinal extension direction L).

The sleeve body 2 comprises a continuous axial channel 3 for receiving a headrest rod 8. The axial channel 3 thus serves as a rod receptacle in which the rod 8 of a headrest is or can be received.

The rod receptacle 3 has a circular cross-section; however, this is not to be understood as a limiting design. According to alternative embodiments, it is of course possible for the rod receptacle 3 to have an oval or non-circular cross-section.

Although not shown in the drawings, the headrest sleeve 1 serves as a guide sleeve, which is arranged in an opening of a backrest of a vehicle seat and via which the rod 8 of a headrest can be affixed to the backrest of the vehicle seat.

The rod 8 can be locked in a plurality of specified positions by a locking element 7 of the headrest sleeve 1, wherein the rod 8 projects more or less out of the rod receptacle 3. To adjust the height of the headrest, the rod 8 can be moved between the specified positions.

The headrest sleeve 1, and in particular the sleeve body 2 of the headrest sleeve 1, is made from a plastic having a high impact strength, which increases the robustness of the headrest sleeve 1 and the sleeve body 2 against the effects of an accident-related impact. The sleeve body 2 can be manufactured from, for example, polyoxymethylene (POM) that has been in particular impact strengthened.

As shown, the head portion 4 of the sleeve body 2 of the headrest sleeve 1 comprises a reinforcement element 5 for reinforcing, and in particular stiffening, of the head portion 4.

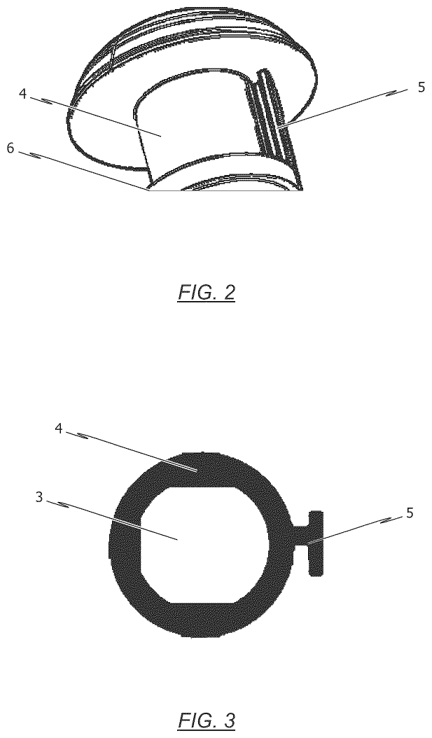

In particular, the illustration in FIG. 2 shows that the reinforcement element 5 extends in the longitudinal extension direction L of the head portion 4 of the sleeve body 2.

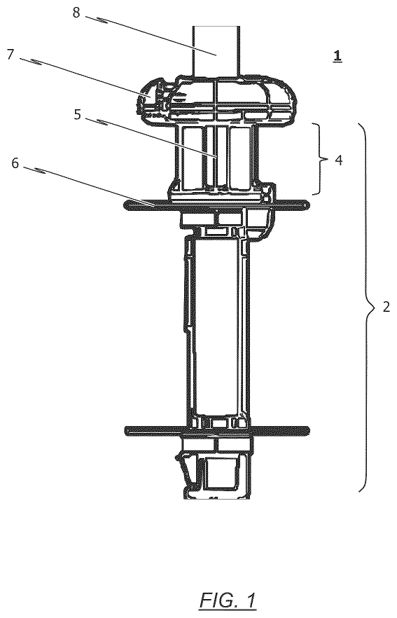

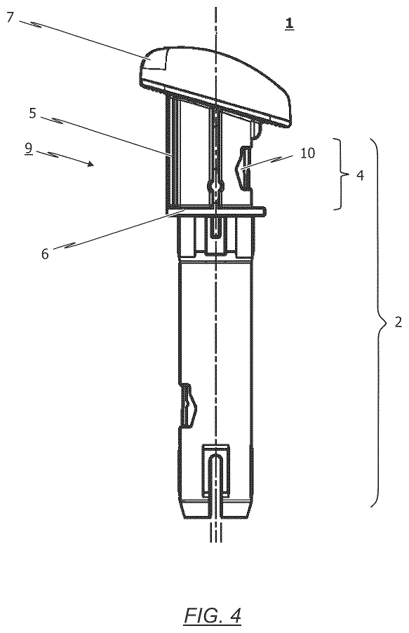

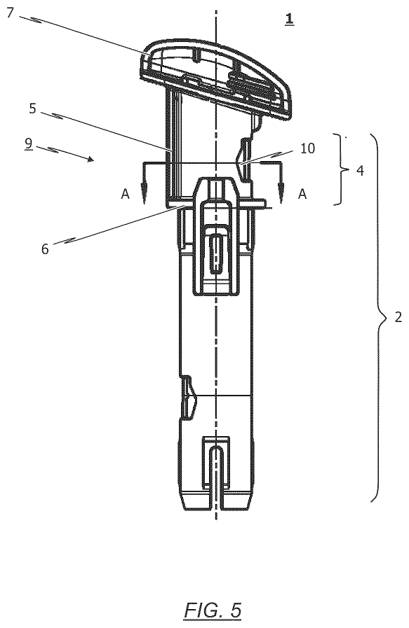

It can be seen in the illustration in FIG. 1, as well as in FIG. 4 and FIG. 5, that the sleeve body 2 comprises a radially outward facing flange region 6 at an upper region of the sleeve body 2, which is molded onto the sleeve body 2 and is designed in particular to be monolithically formed with the sleeve body 2. When the headrest sleeve 1 is used as intended, the flange region 6 abuts against an outer surface of the vehicle seat frame.

In particular, it is provided that the reinforcement element 5 of the head portion 4 of the sleeve body 2 of the headrest sleeve 1 is provided above the flange region 6 and connected there to the head portion 4.

In particular, the reinforcement element 5 is provided exclusively above the flange region 6.

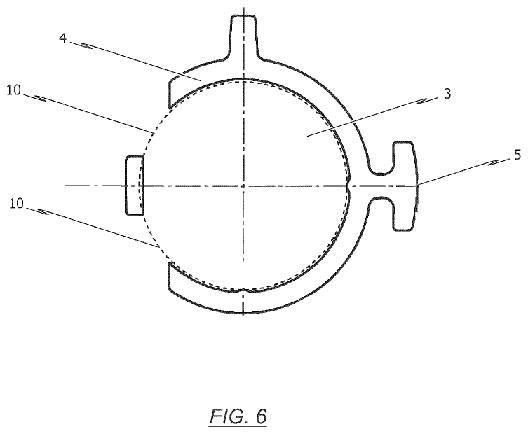

The sectional view in FIG. 3 and in FIG. 6 shows that the reinforcement element 5 is molded onto the head portion 4 and preferably monolithically formed with the head portion 4. In particular, it is provided that the reinforcement element 5 is formed from the same material as the sleeve body 2 or at least as the head portion 4 of the sleeve body.

The reinforcement element 5 is configured to increase the bending stiffness and the torsion stiffness of the sleeve body 2, in particular in the region of the head portion 4.

For this purpose, it is provided in particular that the reinforcement element 5 is provided on the front side 9 of the sleeve body 2, i.e., on the side of the sleeve body 2 that, when the headrest sleeve 1 is used as intended, points in the direction of travel of the vehicle.

Alternatively, or additionally, however, it is also conceivable that the reinforcement element 5 is provided on a rear side of the sleeve body 2 lying opposite the front side 9 of the sleeve body 2.

In the embodiment of the headrest sleeve 1 according to the disclosure as shown in FIG. 4 to FIG. 6, the reinforcement element 5 is provided exclusively on the front side 9 of the sleeve body 2, while in the rear side of the sleeve body 2, a window region 10 is formed.

In particular, the sectional views in FIG. 3 and in FIG. 6 show that the reinforcement element 5 is configured as a reinforcement rib.

Specifically, in the embodiments shown in the drawings, the reinforcement rib has a T-shaped cross-sectional geometry, wherein other cross-sectional geometries are contemplated, in particular an L-shaped or double-T-shaped cross-sectional geometry.

The disclosure further relates to a vehicle seat for a motor vehicle having a backrest and a headrest, wherein a headrest sleeve 1 of the aforementioned type according to the disclosure is arranged on the backrest for affixing the headrest to the backrest.

The above-cited patents and patent publications are hereby incorporated by reference in their entirety. Where a definition or the usage of a term in a reference that is incorporated by reference herein is inconsistent or contrary to the definition or understanding of that term as provided herein, the meaning of the term provided herein governs and the definition of that term in the reference does not necessarily apply.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

1 Headrest sleeve
2 Sleeve body
3 Axial channel/rod receptacle
4 Head portion of the sleeve body
5 Reinforcement element
6 Flange region
7 Locking element
8 Headrest rod
9 Front side of the sleeve body
10 Window region
L Longitudinal extension direction of the head portion

What is claimed is:

1. A headrest sleeve (1) having a sleeve body (2) that can be inserted into at least one opening of a frame of a vehicle seat and comprises a continuous axial channel (3) for receiving a headrest rod (8) and a head portion (4), wherein, when the headrest sleeve (1) is used as intended, the sleeve body (2) is inserted in the opening of the frame of the vehicle seat in such a way that the head portion (4) of the sleeve body (2) is positioned outside or on an outer surface of the frame of the vehicle seat,
wherein the head portion (4) of the sleeve body (2) comprises at least one reinforcement element (5) for reinforcing or stiffening the head portion (4).

2. The headrest sleeve (1) according to claim 1, wherein the at least one reinforcement element (5) extends in a longitudinal extension direction (L) of the head portion (4) of the sleeve body (2).

3. The headrest sleeve (1) according to claim 1, wherein, in an upper region of the sleeve body (2), the sleeve body (2) comprises a radially outwardly directed flange region (6), which is preferably molded onto the sleeve body (2) and monolithically formed with the sleeve body (2), wherein, when the headrest sleeve (1) is used as intended, the flange region (6) abuts against an outer surface of the frame of the vehicle seat, and wherein the at least one reinforcement element (5) is provided above the flange region (6) and connected there to the head portion (4).

4. The headrest sleeve (1) according to claim 3, wherein the at least one reinforcement element (5) is provided exclusively above the flange region (6).

5. The headrest sleeve (1) according to claim 1, wherein the at least one reinforcement element (5) is molded onto the head portion (4) and preferably monolithically formed with the head portion (4).

6. The headrest sleeve (1) according to claim 1, wherein the at least one reinforcement element (5) is formed from the same material as the sleeve body (2) or at least as the head portion (4) of the sleeve body (2).

7. The headrest sleeve (1) according to claim 1,
wherein the at least one reinforcement element (5) is configured to increase a bending stiffness of the sleeve body (2) in a region of the head portion (4); and/or
wherein the at least one reinforcement element (5) is configured to increase a torsion stiffness of the sleeve body (2) in the region of the head portion (4).

8. The headrest sleeve (1) according to claim 1, wherein the sleeve body (2) comprises a front side (9), which, when the headrest sleeve (1) is used as intended, points in a direction of travel of the vehicle, wherein the at least one reinforcement element (5) is provided on the front side (9) of the sleeve body (2) and/or on a rear side of the sleeve body (2) lying opposite the front side (9).

9. The headrest sleeve (1) according to claim 8, wherein the at least one reinforcement element (5) is provided exclusively on the front side (9) of the sleeve body (2) and/or on the rear side of the sleeve body (2).

10. The headrest sleeve (1) according to claim 8, wherein the at least one reinforcement element (5) is provided exclusively on the front side (9) of the sleeve body (2), while a window region (10) is formed in the rear side of the sleeve body (2).

11. The headrest sleeve (1) according to claim 1, wherein the at least one reinforcement element (5) is configured as a reinforcement rib.

12. The headrest sleeve (1) according to claim 11, wherein the reinforcement rib has a substantially L-shaped, T-shaped, or double-T-shaped cross-section.

13. The headrest sleeve (1) according to claim 11, wherein an upper region of the reinforcement rib is configured to increase a bending stiffness of the head portion (4), wherein a lower region of the reinforcement rib is configured to increase a torsion stiffness of the head portion (4).

14. A vehicle seat having a backrest and a headrest, wherein at least one headrest sleeve (1) according to claim 1 is arranged on the backrest to affix the headrest to the backrest.
